(19) United States
(12) Patent Application Publication
(10) Pub. No.: US 2016/0314103 A1
(43) Pub. Date: Oct. 27, 2016

(54) Computer System for Generation of Electronic Checklists

(71) Applicant: CHECKLISTPARTNER PTY LTD, St Lucia (AU)

(72) Inventors: Stephen James Fox, St Lucia (AU); Ramon Donnell, St Lucia (AU)

(21) Appl. No.: 15/200,019

(22) Filed: Jul. 1, 2016

Related U.S. Application Data
(63) Continuation of application No. PCT/AU2014/001107, filed on Dec. 9, 2014.

(30) Foreign Application Priority Data
Dec. 9, 2013 (AU) 2013904788

(51) Int. Cl. G06F 17/22; G06F 3/0482; G06Q 10/10; G06F 3/0484

(52) U.S. Cl. CPC G06F 17/2288; G06F 3/0484; G06F 3/0482; G06Q 10/10

(57) ABSTRACT

A method for providing electronic checklists to subscribers including the steps of:
maintaining an electronic store of publisher checklists in communication with a first computational device such as a server;
operating the first computational device to produce subscriber checklists, derived from the publisher checklists, upon remote subscriber machines across a data network;
operating the first computational device to monitor for reception of modifications to the subscriber checklists from the remote subscriber machines across the data network;
operating the first computational device to mix said modifications from subscribers with corresponding subscriber checklists of said subscribers; and
operating the first computational device to produce the subscriber checklists incorporating the mixed modifications upon the remote machines.

### CROSS REFERENCE TO RELATED APPLICATION

This application is a continuation of and claims the benefit of International Application No. PCT/AU2014/001107 having an international filing date of Dec. 9, 2014 under 35 U.S.C. §120, and which in turn claims priority to Australian Patent Application No. 2013904788 filed on Dec. 9, 2013.

### TECHNICAL FIELD

The present invention relates to a server that is specially programmed to store electronic checklists and to send electronic checklists to subscribers and which is able to process subscriber inputs received across a data network in order to produce checklists incorporating subscriber modifications.

### BACKGROUND

Any references to methods, apparatus or documents of the prior art are not to be taken as constituting any evidence or admission that they formed, or form part of the common general knowledge.

There are many areas where professional service providers have a need to deliver a service in a standardized way that complies with professional practice standards and laws and regulations. It is important to produce evidence to show that the required documentation has been provided to clients and that they have been advised of all relevant facts and circumstances. Failure to comply with professional standards and relevant laws and regulations may result in a substandard product being delivered, which is of course highly unsatisfactory for the client. Furthermore, the delivery of a substandard service may also make the professional service provider vulnerable to a liability claim.

At the moment lawyers, for example, primarily use paper document checklists or in some circumstances electronic checklists. For example, checklists in the form of electronic spreadsheets or as web based applications have been known to have been used.

One issue that arises in the use of computer based checklists of the prior art is that the practitioner may come up with improvements to the checklist but it is very time consuming, or quite impractical, to incorporate the improvements into the checklists. Furthermore, should a practitioner come up with an improvement to an electronic checklist, for example an electronic checklist that is originally produced upon the machine of an expert publisher of checklists, then there is no convenient and automated way for integrating the publisher's content and the practitioner's content.

It is an object of the present invention to provide an improved computer system that addresses one or more of the above described needs or which is at least a useful and commercially viable alternative to computer systems for checklist processing which have hitherto been known in the prior art.

### SUMMARY OF THE INVENTION

According to a first aspect of the present invention there is provided a method for providing electronic checklists to subscribers including the steps of:
maintaining an electronic store of publisher checklists in communication with a first computational device such as a server;
operating the first computational device to produce subscriber checklists, derived from the publisher checklists, upon remote subscriber machines across a data network;
operating the first computational device to monitor for reception of modifications to the subscriber checklists from the remote subscriber machines across the data network;
operating the first computational device to mix said modifications from subscribers with corresponding subscriber checklists of said subscribers; and
operating the first computational device to produce the subscriber checklists incorporating the mixed modifications upon the remote machines.

The method may include operating the first computational device to indicate locking of publisher items of the checklists on the remote subscriber machines and refusing subscriber modification of said locked publisher items.

Preferably the method includes operating the first computational device to receive subscriber sub-items from the remote machines and to add the subscriber sub-items to publisher items wherein checklists rendered upon the remote machines in response to operation of the first computational device, display the added subscriber sub-items to corresponding subscribers.

Where a subscriber operates his or her remote machine to add a subscriber sub-item to a publisher item of a subscriber checklist then the method preferably includes the step of upon a publisher deleting the publisher item, operating the first computational device to present the subscriber sub items along with the deleted publisher item upon a display of the subscriber's remote machine.

In a preferred embodiment of the invention the method includes operating the first computational device to cause the remote machines to produce a page presenting subscribers with an option for submitting a suggestion for a checklist item wherein the option for submitting the suggestion is provided in the checklist that is displayed to the subscriber proximal the checklist item.

Preferably the method further includes subsequently operating the first computational device to cause the remote machines to present subscriber checklists to subscribers including previously received suggestions presented proximal mixed checklist items.

The method may also include operating the first computational device to serve pages to the remote machines of the subscribers to thereby present an electronic forum to subscribers wherein the pages presenting the forum include a plurality of discussion entries that are arranged to correspond to portions of an electronic checklist served by the first computational device.

Preferably the method includes operating the first computational device to create pages for the electronic form that include discussion categories dynamically based on content entered by users into their remote computational devices and received by the first computational device across the data network. For example, in a preferred embodiment of the invention the first computational device is programmed to create a new category in the forum in response to a publisher creating a new item on a publisher checklist.

According to a further aspect of the present invention there is provided a computational device, for example a server that is programmed with a software product comprising instructions for the computational device to carry out the previously described method.

According to another aspect of the present invention there is provided a computer software product comprising a machine readable media bearing instructions for execution by a computational device for carrying out the previously described method.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of a system according to a preferred embodiment of the present invention.

FIG. 2 is a diagram illustrating the relationships between different types of checklists that are produced according to a preferred embodiment of the present invention.

FIG. 3 depicts a checklist and its various parts.

FIGS. 4 to 10 are screen shots of publisher and subscriber machines during the implementation of a checklist mixing process according to a preferred embodiment of the present invention.

FIGS. 11 to 14 are screen shots of publisher and subscriber machines during the implementation of a checklist item orphaning process according to the preferred embodiment of the present invention.

FIGS. 15 and 16 are screen shots of subscriber machines during the implementation of a checklist suggestion process according to the preferred embodiment of the present invention.

FIGS. 17 to 19 illustrate a forum feature of the preferred embodiment of the present invention.

FIG. 20 is a screen shot illustrating a note exchange feature of the preferred embodiment of the present invention.

### DETAILED DESCRIPTION OF PREFERRED EMBODIMENTS

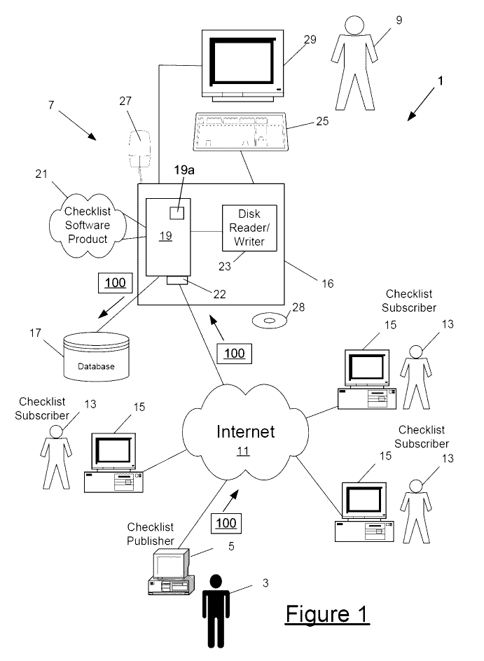

Referring now to FIG. 1 there is shown a block diagram of an exemplary computer system 1 for carrying out a method according to an embodiment of the invention that will be described.

During the performance of the exemplary embodiment of the method, at least one checklist publisher 3 is in data communication, by means of computer 5 with a first computational device in the form of a server 7 (which is maintained by administrator 9), via a data communications network in the form of the Internet 11. The checklist publisher 3 (which might be an individual or a panel of people having expertise in the area that the checklist relates to) is able to submit electronic files comprising checklists 100, or as may be equivalently expressed simply “checklists” to the server 7. The checklist publisher 3 is able to submit the checklist by means of its remote machine, i.e. computer 5 which is in data communication with the server 7 via a data network such as the Internet 11. The server 7 transmits packets of data to the publisher's computer 5 which the publisher is able to view in a browser window running on the computer 5. The checklists 100 that the publisher sends to the server are comprised of data packets comprising lists of items that are tailored to assist professional service providers, e.g. subscribers 13 deliver their services for particular products in a comprehensive and regulation compliant manner.

The server 7 stores the checklists from the publisher machine 5 in a data source in the form of database 17 and makes them available to the remote machines 15 of the subscribers 13 via the Internet 11. The data source may be a suitably programmed server that stores a database across a redundant array of independent disks (RAID). Alternatively it may be a data source hosted by a cloud storage provider.

As will be described in more detail, the subscribers 13 view the checklists in browsers running on their computers 15 and check off items in the checklists as they deliver their various products, e.g. specific professional services, to their clients. For example, one of the subscribers may be a lawyer that provides conveyancing services. In that case, the subscribers account will, by prearrangement between the subscriber 13 and the administrator 9 of the checklist server 7, allow that subscriber 13 be provided with a conveyancing checklist by server 7 for viewing and interaction with upon subscriber computer 15.

The checklist software product 21, that the server 7 executes, is written in Node.JS. As explained at the Node.JS website http://nodejs.org/ “Node.js® is a platform built on Chrome's JavaScript runtime for easily building fast, scalable network applications. Node.js uses an event-driven, non-blocking I/O model that makes it lightweight and efficient, perfect for data-intensive real-time applications that run across distributed devices” (retrieved Aug. 12, 2014).

The first computation device, in the form of server 7 is configured as a server and is of a type suitable for performing the checklist delivery and modification method according to a preferred embodiment of the present invention.

Initially, upon a remote machine, e.g. subscriber machines 15 or checklist publisher machine 5, establishing data communications with the server 7, the server transmits HTML, Javascript and CSS files to the remote machines so that they are able to establish the look and feel of the checklist software in their browser windows. The remote machines 5, 15 thereafter act as “thick” clients, (as opposed to thin clients), in that they perform a substantial part of the computational work needed to produce the various pages that the publisher 3 and subscribers 13 interact with. The remote machines make relatively small application programming interface (API) calls to the server 7 during operation and presentation of the checklists to keep the checklists that are presented updated. This avoids the need for the server 7 to have to perform all of the computational work and to have to continually serve updated pages to the remote machines. Consequently, the subscribers 13 and publishers 5 do not experience continual screen refreshing as they make use of the checklist system. Instead the subscribers and publishers experience a richer, more responsive, user experience which feels like they are interacting with the checklist on a desktop machine running software product 21. Furthermore, the data network bandwidth requirements between the remote machines 5, 15 and the server 7 are modest after the initial downloading of the HTML, Javascript and CSS files has been completed so that data communications between the remote machines and the server do not consume a large amount of network bandwidth

Server 7 includes a computer 16 which, in turn, includes a controller 19 having at least one processor 19a, RAM, ROM and various secondary data storage devices such as a hard disk drive. The controller 19 executes the software product 21 stored in electronic data storage that contains instructions for implementing a method according to an embodiment of the present invention. The software product 21 is typically provided on an optical or magnetically readable medium such as a CD-ROM or floppy diskette 28, which bears tangible machine readable instructions. The machine readable instructions can be read by controller 19 via disk reader 23 for example. Alternatively, software product 21 might be provided in a ROM or other electronic circuit as firmware or downloaded from a remote location over a computer network such as the Internet 11.

The software product 21 includes instructions for system 7 to implement a method, according to a preferred embodiment of the present application that will be explained in more detail below.

By means of conventional interfacing circuitry of computer 16, the controller 19 receives commands entered by an administrator 9 from human-machine interface devices such as keyboard 25 and mouse 27 (or via remote terminal), and displays information on display 29. Controller 19 communicates with a number of peripheral devices including the disk reader/writer 23 and a network data port 22.

Other computers illustrated in FIG. 1, i.e. publisher remote machine 5 and subscriber remote machines 15, have a similar hardware composition to that of server 7 although some are suitably programmed with a desktop operating system and may or may not include software modules capable of serving websites. It will also be realised that while icons for desktop computers are used in FIG. 1, the computers, i.e. the remote machines, might be tablets, smartphones, laptops, netbooks or any other kind of suitable computational device.

The above provides an overview of a preferred method and hardware system according to a preferred embodiment of the present invention. The individual steps of the method that the server 7 is configured to implement under control of the instructions coded into software product 21 will now be explained in more detail

As previously mentioned, the method that the server 7 implements under control of software 21, or as it is sometimes referred to herein “Checklist Partner”, provides a way for businesses to improve process efficiency and confidence through the use of pragmatic, reusable and improvable checklists.

Industry standard checklists are published on the system 7 by domain experts, i.e. the at least one publisher 3, and subscribers 13 can access these using their remote machines 13 during their product delivery to clients for guidance and record keeping. Subscribers 13 can also improve Publisher Checklists by adding individualized business process content.

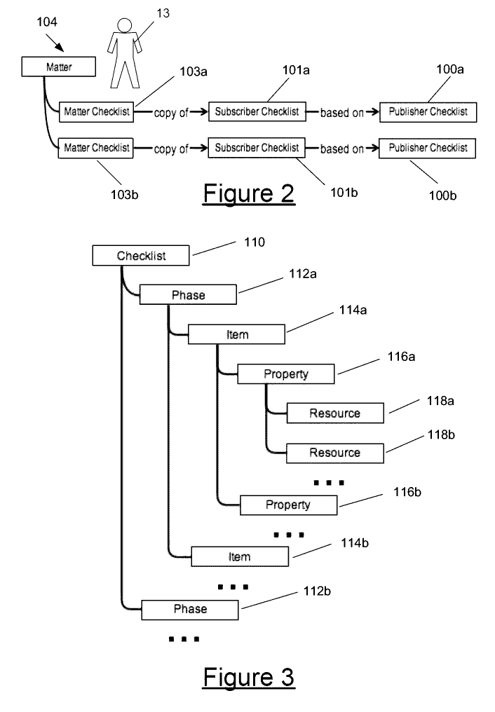

As illustrated in FIG. 2, during their interactions with server 7 subscribers create Matters 104, i.e. specific electronic case files on their remote machines 15 comprising matter checklists 103a, 103b, which are copies of subscriber checklists 101a, 101b and which are based on publisher checklists 100a, 100b. Each matter 104 comprises one or more data structures that are created and stored by the server 7 and populated with data that is provided by the publishers 3 and subscribers 13. The server 7 is programmed to allow subscribers 13 to record information against checklist items in the matter checklists 103a, 103b. The recorded information will typically comprise information such as, file notes, documents, completions and client authorizations.

As previously discussed, the checklist software application is a service provided by server 7, which might be cloud hosted, and accessed via web browsers running on subscriber computers 15. Information entered by users, i.e. Publishers 3 and Subscribers 13, is stored on the checklist servers, i.e. datasource 17 under control of server 7 and possibly also other cloud services.

A number of terms will be used during the description of the preferred embodiment of the invention as set out in Table 1, below.

TABLE 1

| | | |
|---|---|---|
| Term | Description | Example |

User Roles

| | | |
|---|---|---|
| Publisher | A a person or organisation | Stronghold and Bar |
| | with users who can access the | Publishers |
| | System and can create | |
| | Checklists | |
| Subscriber | A person or organisation with | Peter Smith Lawyers |
| | users who can access the | |
| | System and use Checklists | |
| | for matters | |

Checklists

| | | |
|---|---|---|
| Checklist | A collection of information | Publisher Template |
| Template | pertaining to a particular area | Subscriber Template |
| | of expertise. | |
| | Contains a collection of | |
| | phases with items, properties | |
| | and resources. | |
| Publisher | A Checklist Template created | Conveyancing - Acting |
| Template | by a Publisher | for Purchaser |
| Subscriber | A Checklist Template based | Estate Planning |
| Template | on a Publisher | |
| | Template, modified by a | |
| | Subscriber | |
| Matter | A copy of a Subscriber | Estate Planning |
| Checklist | Template for use in a matter | |

Matters

| | | |
|---|---|---|
| Matter | A collection of Matter | SMITH001ABC |
| | Checklists and other data | |
| | pertaining to an actual matter | |
| | for a client. | |
| | Used by Subscribers for | |
| | guidance and record keeping. | |

Checklist Content Hierarchy

| | | |
|---|---|---|
| Phase | A collection of items. Used to | Prepare Estate Plan |
| | logically group related items. | Consider Capacity |
| Item | A specific step to be taken by | Check that Estate Plan |
| | a Subscriber User. May be | deals with all items of |
| | an instruction or a question. | property (refer EIM) |
| | Contains a collection of | |
| | properties. | |
| Property | A specific piece of | Due Date, Contact, |
| | information associated to a | Knowledge |
| | property. | Resources, |
| | May contain resources. | Discussion |
| Resources | A collection of information for | www.lawsite.com/estat |
| | a property. | es/eim-information |
| | May be a text note, URL or | |
| | file attachment | |

Social, Discussions, Forum

| | | |
|---|---|---|
| Discussion | A property on an item that | Questions and answer |
| Property | contains an forum like | about an item |
| | discussion for that item | |
| Suggestion | Same as Phase, Item, etc.. | New created |
| | but made available to other | Subscriber Item |
| | users as a suggestion rather | |
| | than a part of the checklist | |
| Forum | A discussion platform with | |
| | categories based on the | |
| | structure of the published | |
| | checklists | |

Referring again to FIG. 2, a subscriber 13 when doing work on a matter 104 refers to matter checklists 103a, 103b (or possibly more matter checklists) which are displayed in a browser window on the subscriber's remote machine 15. The matter checklists 103a, 103b that are displayed are snapshots of subscriber checklists 101a, 101b that the server 7 is programmed to create and serve to the subscriber machine 15 based upon publisher checklists 100a, 100b.

FIG. 3 depicts the structure of a checklist 110 that is stored in the database 17 of the server 7. In a preferred embodiment of the invention checklists, such as that depicted in FIG. 3, are implemented as Javascript data objects that are coded into the checklist software product 21. It will of course be realized that other programming languages could be used to implement the invention. The checklist 110 is comprised of a number of phases 112a, 112b, which divide the checklist into portions or chapters of items. In use a checklist for a lawyer relating to a conveyancing matter, for example, may include a phase 112a that is made up of a number of items 114a, 114b that require the lawyer to tick off on collecting client details and which are concerned with identifying the details of the property that are subject of the conveyance.

Each item 114 has a number of properties, e.g. property 116, which in turn have one or more resources, e.g. resources 118a, 118b. Some items include properties which have resources to present questions to the subscriber to answer and in response to the answer present sub-items for checking off by the subscriber. Other properties of an item may include textual examples, precedents, file notes, contacts (for example the contact details for a relevant regulatory authority), dates (for example due dates for completing tasks associated with the checklist). All of the checklist, phase, items and properties and their relationships to each other are stored in suitable data structures that are created by server 7 in accordance with corresponding instructions coded in the software product 21.

As a subscriber 13 operates remote machines 15 to use a checklist 110 that has been provided by a publisher it is often the case that the subscriber would like to add new checklist items to the checklist.

A problem that has occurred in the past with computer systems for generating and processing checklists is that the “template” (if there is a template) is provided by a publisher/expert/provider (eg publisher's template provides for tasks ABCD) and then the user takes a copy of that template and then:

i. The computer system receives and adds the user's improvements/amendments to the checklist and thereby creates a, modified users own template checklist. Eg the user adds EF and then the users template reads ABCDEF;
ii. There is no further integration between the publisher's checklist and the user's checklist because either it has hitherto been too difficult to implement the additional integration in the computer system or the benefits of such additional integration have not been realized.

As will be discussed further shortly, the Checklist software 21 includes instructions for the computer system 7 to integrate or “mix” the publisher content and the user content so that:

i. The “template” is provided by a publisher/expert/provider by operation of their remote machine 3 which is in data communication with the computer system 7. For example, the publisher's checklist 110 (FIG. 3) which is transmitted from remote machine 3 to the computer system 7 provides a template for tasks ABCD);
ii. The user, e.g. a subscriber 13 or another publisher 3 can, by means of its remote machine 5, 15 add the user's improvements/amendments to the checklist and thereby create the “users own template checklist”. Eg the user adds EF and then the user's template reads ABCDEF;
iii. The software product 21 includes instructions for the server 7 to process publisher's improvements transmitted from the publisher's machine 5 to thereby add the publisher's improvements eg A1,B1 to the publisher's checklist;
iv. The user's checklist would then appear as;
1. The Publisher's initial checklist ABCD;
2. The user's additions EF
3. The Publisher's improvements A1, B1
   v. That is, the computer system 7 under the control of the Checklist software 21 “integrates” the respective improvements from the Publisher and the user—into a single checklist for the given process.

“Mixing” of the subscriber items with the publisher checklist items is possible to do using a functionality of the software 21 running on the server 7 which will now be described further.

The Checklist software 21 includes instructions for the server 7 to provide a mixing feature that combines Publisher content and Subscriber content in a seamless fashion for use in Matter Checklists.

The software 21 includes instructions for server 7 so that at least the following checklist content is available for mixing:
Phases
Items
Properties
Resources

Table 2, below, sets out the various terms that will be referred to in describing the mixing function.

TABLE 2

| Term | Description |
|---|---|
| Publisher | Checklist, Phase, Item, Properties or resources created by a |
| Content | Publisher |
| Subscriber | Checklist, Phase, Item, Properties or resources created by a |
| Content | Subscriber in addition to the Publisher Content |
| Matter | Checklist, Phase, Item, Properties or resources created by the |
| Content | a Subscriber on a Matter Checklist in addition to the Publisher |
| | Content and Subscriber Content |
| Locked | Publisher Content that is unchangeable when viewed by a |
| Content | Subscriber |
| Orphaned | Subscriber Content that is dependent on Publisher Content is |
| | presented to the Subscriber as orphaned when that Publisher |
| | Content is removed |

An example of item mixing will now be described with reference to FIGS. 4 to 10. This example shows screens that the server, i.e. computer system 7, under control of software 21, causes the remote machines 5, 15 of a Publisher 3 and a Subscriber 13 to produce. These are screens that the Publisher 3 and Subscriber 13 are presented with when making changes to Checklist Items. The same process applies to Phase, Item Properties and resources.

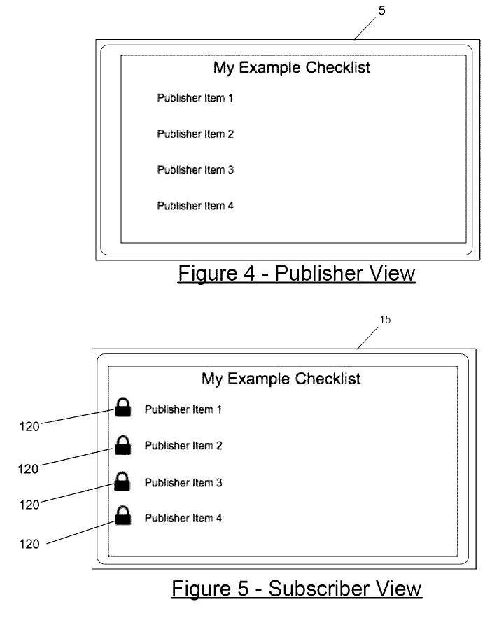

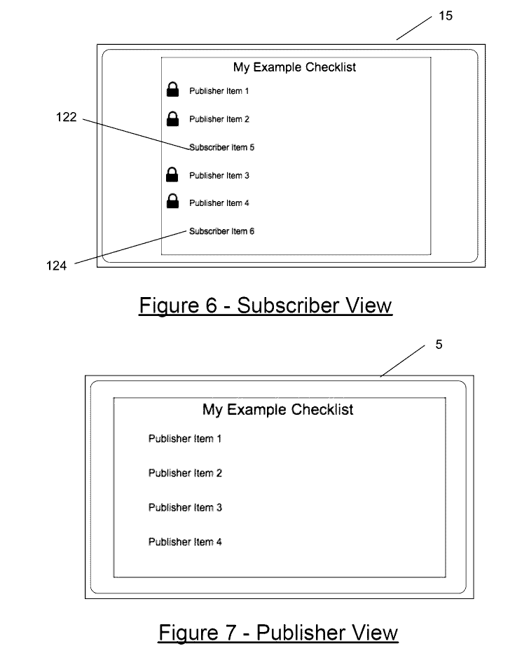

Referring now to FIGS. 4 and 5, the subscriber checklist (that is displayed in FIG. 5) is based on the publisher checklist (displayed in FIG. 4). The server 7 indicates that the publisher items are locked as far as the subscriber is concerned, that is, the subscriber cannot modify them as indicated by the “padlock” icons 120 in FIG. 5. However, the subscriber is presented with options in the browser of remote machines 15 to allow the subscriber 13 to add items to the subscriber checklist. FIG. 6 shows the screen that the subscriber's machine 15 presents in response to data packets from server 7 and which is presented to the subscriber 13, showing the subscriber checklist after new items, Subscriber items, 5 (122) and 6 (124) have been added. It will be noted that the server 7 under control of software 21 indicates that these items are unlocked.

However, the checklist software 21 is programmed so that the server 7 ensures that the subscriber's new items are restricted to the subscriber checklist (see FIG. 2) so that the publisher checklist, which server 7 causes to be produced upon remote publisher machine 5 remains unaltered as shown in FIG. 7.

FIG. 8 illustrates the situation where the server 7 executes instructions in the software product that allow the publisher 3 to modify (by means of its machine 5) items in the publisher checklist that is stored in data storage 17. In this case the publisher 3 has, via its machine 5, modified some of the properties of item 1, (126). The publisher has also added New Item 7,(128) to the checklist.

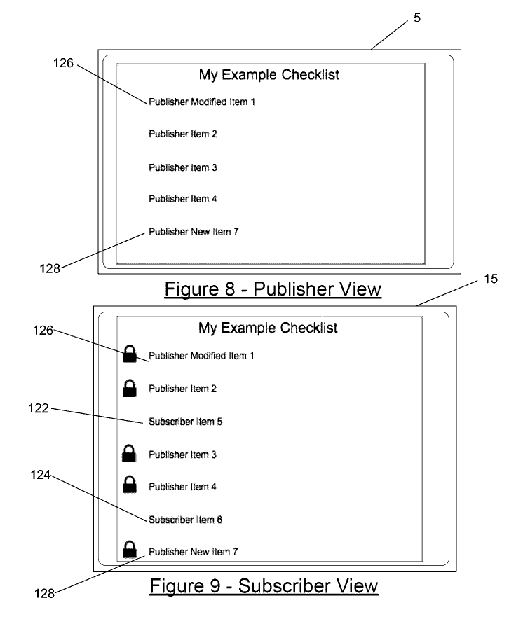

FIG. 9 is a screen view of the corresponding subscriber checklist and shows how the server 7, under control of checklist software 21 conveys the publisher checklist changes to the corresponding subscriber checklist. It will be noted that the modification to item 1, (126) and the new item 7, (128) are propagated to the subscriber checklist as locked items and displayed along with the subscriber items 5, (122) and 6, (124).

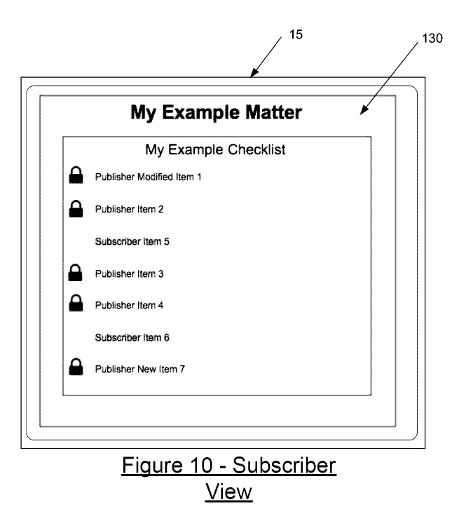

Software 21 includes instructions for server 7 to transmit data packets to cause matter checklist 130 to display on the screen that is shown in FIG. 10 Checklist 130 is displayed upon the subscriber machine 15 when the subscriber operates its machine 15 to create a new matter checklist that uses the subscriber “My Example” checklist of FIG. 9. The matter checklist 130 is a copy of the subscriber checklist of FIG. 9 in which the publisher content is locked. It will be observed that the subscriber content is unlocked and the subscriber can, by means of its remote machine 15 send commands across the data network, i.e. Internet 11, for the server 7 to modify or add items into a checklist. Furthermore, the subscriber 13 may choose to update the subscriber checklist in which case the software 21 causes server 7 to update the checklist records in data source 17 to ensure that the item in question will be visible only for this specific matter and will not appear on subsequent subscriber checklists.

FIGS. 11 to 14 illustrate the effects of a publisher deleting or “orphaning” checklist items from a publisher checklist and show the respective checklists that the Publisher and a Subscriber are presented with by server 7 when the Publisher deletes Checklist Items. The same process applies to publisher deletion of Phase, Item Properties and resources.

FIG. 11 shows the situation for a checklist 135 after a subscriber has added sub items 5, (131) and 6, (132) to a publisher item 2 (134). It will be observed that the server 7 under control of software 21 causes the publisher item 2 (134) to remain locked so that it can only be modified, or deleted, by the publisher using its remote machine 5 to communicate with server 7 across data network 11.

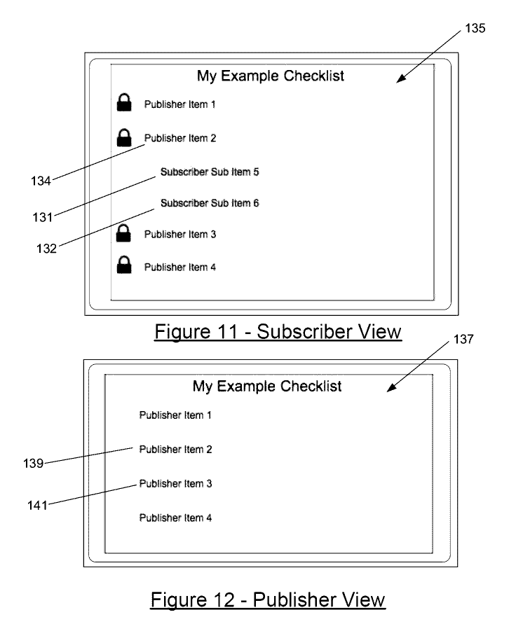

FIG. 12 shows a screen on remote publisher machine 5 displaying a checklist 137 that the server 7 serves to the publisher's remote machine 5. The checklist 137 comprises the publisher's view of the corresponding publisher checklist, which the modified subscriber checklist 135 of FIG. 11 is based upon. As might be expected from the previous examples the software 21 is programmed for the server 7 to ensure that subscriber changes to the subscriber checklist 137 shown in FIG. 12 are not propagated by server 21 back to the publisher checklist. The inventors have programmed the software in this way because they have realized that the publisher checklist is the basis for the subscriber checklists of many subscribers, each of which might make their own independent modifications to their respective subscriber checklists.

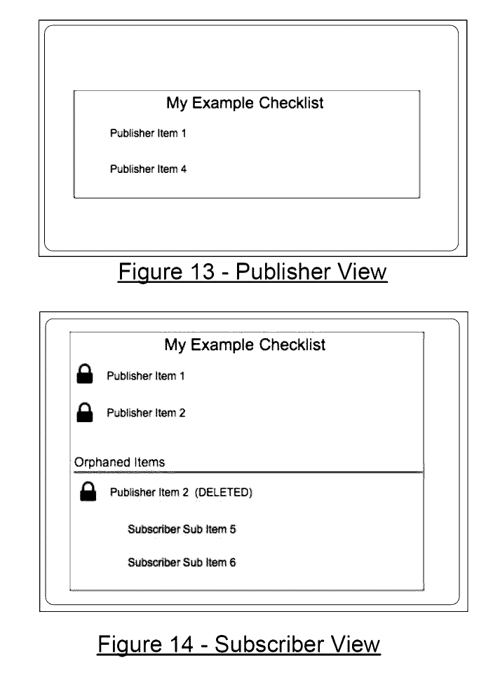

FIG. 13 shows the publisher checklist after the publisher has deleted items 2 (139, FIG. 12) and 3 (141, FIG. 12). Such deletion might be due, for example, to changes in regulatory requirements which impact on items of a particular checklist so that those items are no longer appropriate.

FIG. 14 illustrates the screen that the server 7 serves to the subscriber machine 15 subsequent to the deletion of items 2 and 3 from the publisher checklist. The Subscriber is shown the Subscriber Sub Items 5 and 6 as Orphaned. The Orphaned Subscriber Items are shown in context, i.e. as parented to Publisher item 2. This is so that the subscriber can understand what has happened to the subscriber sub items 5 and 6 which now no longer appear as part of the subscriber checklist proper.

The software 21 includes instructions for the server 7 to apply the mixing feature to all of the checklist, ie the Checklist software includes instructions for the server to integrate and improve publisher checklists by mixing everything eg:

i. The items (tasks) to be completed in a checklist;
ii. The help items eg knowledge content in an item.
iii. The precedent or example documents available on an item;

In the above we have dealt only with the Items (Tasks) However, the Checklist software also provides that for each item the publisher can provide “content” in the form of help, knowledge, links, precedent documents etc. The mixing principle applies to those items of content. For example the Publisher can provide Precedents P1 and P2 and then the Subscriber can add the subscriber's precedent 51 and then after the subscriber has used the checklist for a file (or whilst using the checklist for a file) the Publisher adds a new precedent P3 and the Subscriber adds a new precedent S3.

The next time the checklist is used by the Subscriber that item in that checklist will show all those precedents—namely P1P2P3 S1S2S3

It is also possible to mix “open” files that are using the same checklist. Mixing open files may be desirable because where the process is improved the user may want a new improvement to immediately “flow through” to current files. Mixing applies to all improvements whether they originate with publishers, subscribers or other users. Furthermore the principal of “live mixing”, i.e. mixing of open files applies to all “content” (e.g. knowledge or wisdom) that is added to a file. In a further embodiment of the invention the software product 21 may include instructions for the server 7 to implement a peer approval feature whereby content that is added to a checklist by users in a file can be voted on by other subscribers for inclusion into the master checklist

A problem with programming any computer system for checklist production and management is that of keeping the checklists “up to date”. The Inventors have conceived that a way of assisting to keep the checklist current is to program the server 7 to enable “users to contribute ideas” so that the checklist is timely and complete. That is the server 7 is programmed to accept data relating to the checklists that it stores in data storage device 17 from remote machines, e.g. subscriber machines 15 and publisher machines 5, across the data network in the form of Internet 11.

The Checklist software 21 includes instructions for the server 7 to provide a suggestion feature that allows publishers and subscribers to create content and mark it as suggested, opening it up for discussion and later incorporation into Publisher content.

Suggestions can be made on at least the following content:
Topics
Checklists
Phases
Items

Suggestions are made in context to related content and appear similar to other content but indicated as a suggestion. The suggested item can be used or ignored as required.

It will be realized that the system allows the checklist to be always up to date by suggestion function. The suggestion function works as follows:

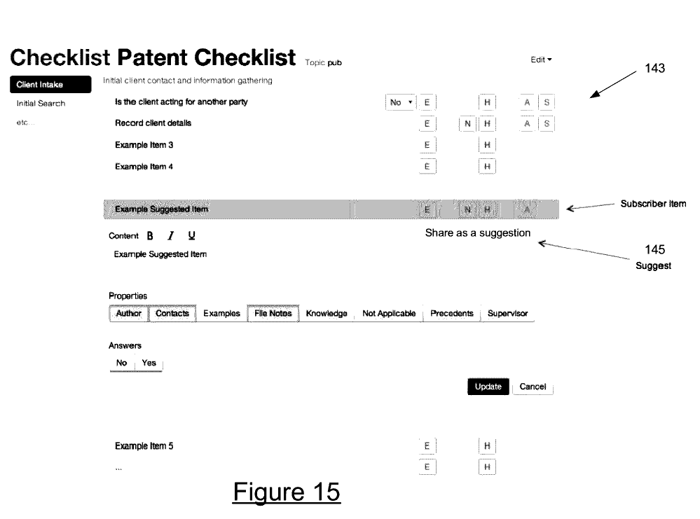

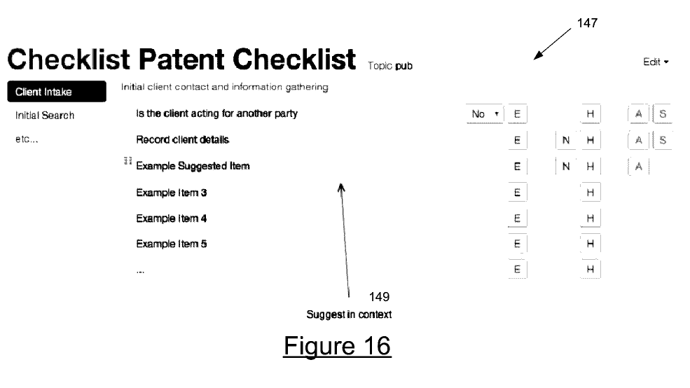

i. A user can add an additional item (task) to the user's checklist (noting that a user's amendments do not amend the Publisher's checklist). With reference to screen 143 of FIG. 15, the software 15 includes instructions for the server 7 to cause subscriber remote machine 15 to allow a subscriber 13 to create a new item and select “Share as a suggestion”.
ii. The user can “share” the user's additional item with the Publisher and all users of the checklist by clicking “share” on the item.
iii. When the user pushes “share” the server 7 is programmed to respond by placing the item into the Publisher's checklist as a “suggestion”, which is very helpful because:
1. It enables users to take a community interest in the checklist as a way to complete a file—ie to quickly contribute to building a checklist;
2. It means that the “standard” in the profession is efficiently maintained/improved
3. It means that each user of the checklist has the ability to achieve “best practice” on each file. In this regard screen 147 of, FIG. 16 shows how the server 7 is programmed so that a different Subscriber viewing the same checklist and is shown the suggestion in context in the checklist.

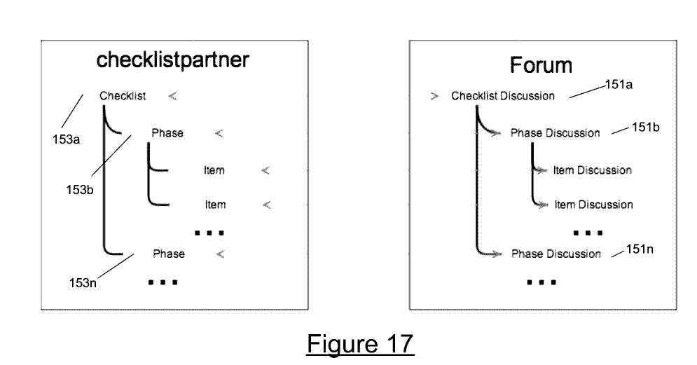

Referring now to FIG. 17, the Checklist software provides a discussion feature that allows social conversations, 151a, . . . ,151n between subscribers via their remote machines 15. These discussions are categorized by the content, 153a, 153n created by checklist users, e.g. publishers 3 and subscribers 15.
Topics
Checklists
Phases
Items

The Checklist Forum is implemented by a module of software 21 that includes instructions for server 7 to provide access to all conversation generated in checklist without requiring access to the checklist.

Typically, in the past, forum discussions groups have been categorized to narrow focus of the discussions and provide easier navigation to relevant content. These categories are usually few and maintained by the forum moderator.

Consequently a difficulty that occurs with prior art discussion forums is that practitioners may encounter particular issues with the filling out of a checklist and so need to ask specialized questions.

In contrast to that prior art approach, in a preferred embodiment of the present invention the Checklist software 21 includes instructions for the server to create categories that are dynamically based on the content created by users. For example when a Publisher creates a new Item on a Checklist, the server 7 under control of software 21 creates a Category in the electronic files comprising the Forum with the name of the Item and the context. The context being which Checklist and Phase it was created under.

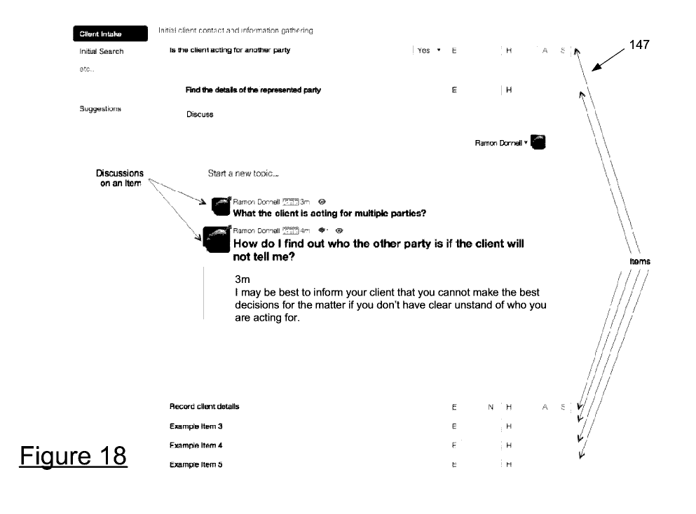

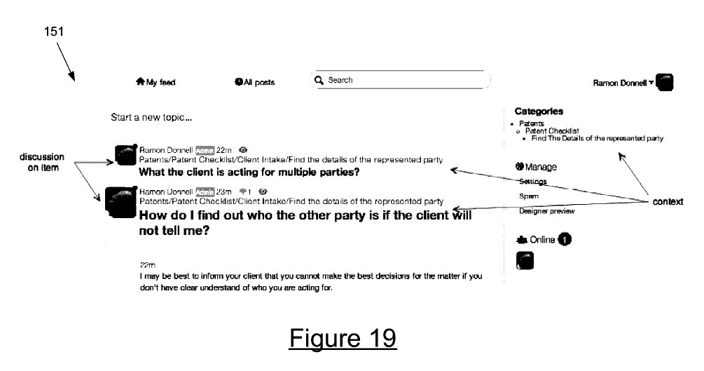

FIG. 18 depicts an example screen 155 of an Item Discussion and FIG. 19 depicts an example screen 157 of a Forum Discussion. These screens 155 and 157 are accessible to publishers 3 and subscribers 13 via their remote machines 5, 15 during implementation of a preferred embodiment of the present invention.

It will be observed that the Checklist program uses the checklist to organize the forum comments. By providing for each checklist item (or task) to have its associated forum discussion the checklist software organizes the forum information. Furthermore, by providing for each checklist item (or task) to have its associated forum discussion the checklist software provides the user with the forum “topic” and then the user can comment or question re that topic. The fact that the forum is “in” the checklist means that the user sees the forum when the user needs the info—as opposed to going to the internet forum and looking for a forum discussion (or other information) that relates to the topic at issue (i.e. the checklist topic).

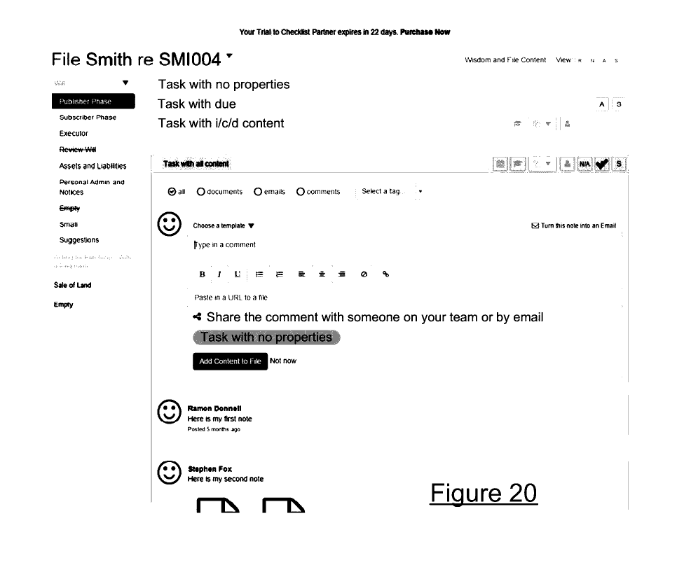

Additional features may be included in further embodiments of the present invention as follows:
1. The software 21 may include instructions for the server 7 to provide a number of “tools” to enable a user (including a publisher) to create a checklist.
2. The software 21 may include instructions for the server 7 to enable a user (where the user is either a publisher or a subscriber) to “draft” a new task—and label it as “draft” or “proposed” and then subsequently “publish” the draft.
3. The software 21 may include instructions for the server 7 to mark a change—where the change is any change (for example an additional task or deletion of a task) in the system so that users know what is changed;
4. The software 21 may include instructions for the server 7 to enable a user to use mind mapping tools (existing or new software) to integrate with the checklist system and “convert” a mindmap of a process into a checklist and vice versa.
5. The software 21 may include instructions for the server 7 enable a user to delegate a task/item to another person.
6. The software 21 may include instructions for the server 7 to enable any person to become a publisher and then publish a checklist. The person would be motivated by a revenue sharing arrangement.
7. The software 21 may include instructions for the server 7 to enable a user to authorise another person (eg a client) to view (and use in a limited manner) the user's checklist—for information, reporting and limited interaction purposes.
8. The software 21 may include instructions for the server 7 to provide a “dashboard” on the remote machines 5, 15 to provide users, e.g. subscribers and publishers with a view of the available information and to provide a measure of the status of files by reference to which steps are complete/incomplete.
9. The software 21 may include instructions for the server 7 to provide for all content (eg communications, notes, documents etc) to be added to a task—which is the logical and obvious place for the information (content) to be dealt with and filed (stored). FIG. 20 is an example of a screen that the server 7 causes to be produced on a remote machine 5, 15 that includes communications in the form of notes from different subscribers.

### Other Implementation Details

The detailed description contained herein refers to customized processes performed by a specially programmed computer, i.e. server 7. The processes and operations performed by the computer include the manipulation of signals by a processor, i.e. processor 19a of processor 19 and the maintenance of these signals within data packets and data structures resident in one or more media within memory storage devices. Generally, a “data structure” is an organizational scheme applied to data or an object so that specific operations can be performed upon that data or modules of data so that specific relationships are established between organized parts of the data structure. For example, the server 7 operates under control of instructions in software product 21 to create data structures corresponding to that depiected in FIG. 3.

A “data packet” is type of data structure having one or more related fields, which are collectively defined as a unit of information transmitted from one device or program module to another. For example, the server 7 transmits data packets that comprise files such as HTML, Javascript and CSS files and also data packets in response to API calls from the remote machines 5, 15 across data network 11. Thus, the symbolic representations of operations, for example the various screens and diagrams shown herein, are the means used by those skilled in the art of computer programming and computer construction to most effectively convey teachings and discoveries to others skilled in the art.

For the purpose of this discussion, a process is generally conceived to be a sequence of computer-executed steps leading to a desired result. These steps generally require physical manipulations of physical quantities. Usually, though not necessarily, these quantities take the form of electrical, magnetic, or optical signals capable of being stored, transferred, combined, compared, or otherwise manipulated. It is conventional for those skilled in the art to refer to representations of these signals as bits, bytes, words, information, data, packets, nodes, numbers, points, entries, objects, images, files or the like. It should be kept in mind, however, that these and similar terms are associated with appropriate physical quantities for computer operations, and that these terms are merely conventional labels applied to physical quantities that exist within and during operation of the computer.

It should be understood that manipulations within the computer are often referred to in terms such as transmitting, issuing, sending, altering, presenting, serving, adding, disabling, locking, unlocking, determining, comparing, reporting, and the like, which are often associated with manual operations performed by a human operator. The operations described herein are machine operations performed in conjunction with various inputs provided by a human operator or user that interacts with the computer.

### Hardware

It should be understood that the programs, processes, methods, etc. described herein are not related or limited to any particular computer or apparatus, nor are they related or limited to any particular communication architecture, other than as described. Rather, various types of general purpose machines, sensors, transmitters, receivers, transceivers, and network physical layers may be used with any program modules and any other aspects of the invention constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read-only memory.

### Program

In the preferred embodiment where any steps of the present invention are embodied in machine-executable instructions, e.g. the instructions making up software product 21, the instructions can be used to cause a general-purpose or special-purpose processor which is programmed with the instructions to perform the steps of the present invention. Alternatively, the steps of the present invention might be performed by specific hardware components that contain hardwired logic for performing the steps, or by any combination of programmed computer components and custom hardware components.

The foregoing system may be conveniently implemented in a program or program module(s) that is based upon the diagrams and descriptions in this specification. Although node.JS is preferred to implement the software product 21 no particular programming language has been required for carrying out the various procedures described above because it is considered that the operations, steps, and procedures described above and illustrated in the accompanying drawings are sufficiently disclosed to permit one of ordinary skill in the art to practice the present invention.

Moreover, there are many computers, computer languages, and operating systems which may be used in practicing the present invention and therefore no detailed computer program could be provided which would be applicable to all of these many different systems. Each user of a particular computer will be aware of the language and tools which are most useful for that user's needs and purposes.

The invention thus can be implemented by programmers of ordinary skill in the art without undue experimentation after understanding the description herein.

### Product

The present invention is composed of hardware and computer program products which may include a machine-readable medium, e.g. disk 28 of FIG. 1, having stored thereon instructions which may be used to program a computer, e.g. server 7 (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnet or optical cards, or other type of media/machine-readable medium suitable for storing electronic instructions. Moreover, the software portion of the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

### Components

The major components (also interchangeably called aspects, subsystems, modules, functions, services) of the system and method of the invention, and examples of advantages they provide, are described herein with reference to FIG. 1. FIG. 1 includes process/means blocks, each block, separately or in combination, is alternatively computer implemented, computer assisted, and/or human implemented. Computer implementation optionally includes one or more conventional general purpose computers having a processor, memory, storage, input devices, output devices and/or conventional networking devices, protocols, and/or conventional client-server hardware and software. Where any block or combination of blocks is computer implemented, it is done optionally by conventional means, whereby one skilled in the art of computer implementation could utilize conventional algorithms, components, and devices to implement the requirements and design of the invention provided herein.

### Web Design

Any web site aspects/implementations of the system include conventional web site development considerations known to experienced web site developers. Such considerations include content, content clearing, presentation of content, architecture, database linking, external web site linking, and number of pages, overall size and storage requirements, maintainability, access speed, use of graphics, choice of metatags to facilitate hits, privacy considerations, and disclaimers.

### Other Implementations

Other embodiments of the present invention and its individual components will become readily apparent to those skilled in the art from the foregoing detailed description. As will be realized, the invention is capable of other and different embodiments, and its several details are capable of modifications in various obvious respects, all without departing from the spirit and the scope of the present invention. Accordingly, the drawings and detailed description are to be regarded as illustrative in nature and not as restrictive.

It is therefore not intended that the invention be limited except as indicated by the appended claims.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect. The invention is, therefore, claimed in any of its forms or modifications within the proper scope of the appended aims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

What is claimed is:

1. A method for providing electronic checklists to subscribers including the steps of:
maintaining an electronic store of publisher checklists in communication with a first computational device;
operating the first computational device to produce subscriber checklists, derived from the publisher checklists, upon remote subscriber machines across a data network;
operating the first computational device to monitor for reception of modifications to the subscriber checklists from the remote subscriber machines across the data network;
operating the first computational device to mix said modifications from subscribers with corresponding subscriber checklists of said subscribers; and
operating the first computational device to cause presentation of the subscriber checklists incorporating the mixed modifications upon the remote machines.

2. The method of claim 1, including operating the first computational device to indicate locking of publisher items of the checklists upon electronic displays of the remote subscriber machines and refusing subscriber modification of said locked publisher items.

3. The method of claim 1, including operating the first computational device to receive subscriber sub-items from said remote machines and to add the subscriber sub-items to publisher items wherein checklists rendered upon the remote machines in response to operation of the first computational device, display the added subscriber sub-items to corresponding subscribers.

4. The method of claim 3, wherein where a subscriber operates his or her remote machine to add a subscriber sub-item to a publisher item of a subscriber checklist then the method includes a step of upon a publisher deleting the publisher item, operating the first computational device to present the subscriber sub items along with the deleted publisher item upon a display of the subscriber's remote machine.

5. The method of claim 1, including operating the first computational device to cause the remote machines to produce a page presenting subscribers with an option for submitting a suggestion for a checklist item wherein the option for submitting the suggestion is provided in a checklist that is displayed to the subscriber proximal the checklist item.

6. The method of claim 5, further including subsequently operating the first computational device to cause the remote machines to present subscriber checklists to subscribers including previously received suggestions presented proximal mixed checklist items.

7. The method of claim 1, including operating the first computational device to serve pages to the remote machines of the subscribers to thereby present an electronic forum to subscribers wherein the pages presenting the forum include a plurality of discussion entries that are arranged to correspond to portions of an electronic checklist produced by the first computational device.

8. The method of claim 7, including operating the first computational device to create pages for the electronic forum that include discussion categories dynamically based on content entered by users into their remote computational devices and received by the first computational device across the data network.

9. The method according to claim 8, wherein the first computational device is programmed to create a new category in the forum in response to a publisher creating a new item on a publisher checklist.

10. A first computational device in the form of a computer server that is programmed to carry out the method of claim 1.

11. A non-transitory computer software product comprising a machine readable media bearing tangible instructions for execution by a computational device for carrying out a method according to claim 1.
